(19) United States
(12) Patent Application Publication
(10) Pub. No.: US 2011/0227474 A1
(43) Pub. Date: Sep. 22, 2011

(54) PLASMA DISPLAY DEVICE

(75) Inventor: Shozo OSHIO, Osaka (JP)

(73) Assignee: Panasonic Corporation, Osaka (JP)

(21) Appl. No.: 13/047,058

(22) Filed: Mar. 14, 2011

(30) Foreign Application Priority Data
Mar. 16, 2010 (JP) 2010-059033

(51) Int. Cl. H01J 1/63

(52) U.S. Cl. 313/483

(57) ABSTRACT

A plasma display device has a plasma display panel including phosphor layers 35 which emits light through electric discharge to output blue, green, and red lights, wherein at least one of the green light and the red light is a wavelength-converted light which is a light emitted from a first phosphor and wavelength-converted by a second phosphor, the first phosphor is a phosphor selected from a plurality of phosphors having an emission peak in a wavelength region ranging from at least 200 nm to less than 600 nm, the second phosphor used to emit the green light is a green phosphor having an emission peak in a wavelength region ranging from at least 500 nm to less than 560 nm, and the second phosphor used to emit the red light is a red phosphor having an emission peak in a wavelength region ranging from at least 600 nm to less than 780 nm.

### BACKGROUND OF THE INVENTION

1. Field of the Invention

The present invention relates to a plasma display device and, more particularly to a plasma display device provided with phosphors with a short afterglow and high luminance which are suitable for stereoscopic display.

2. Description of the Related Art

A plasma display device equipped with a plasma display panel (hereinafter, called PDP) enables a higher definition and a larger screen. Thus, the plasma display device is progressively productized into, for example, 100-inch television receivers.

Describing PDP, typically, a video signal voltage is selectively applied to display electrodes to discharge a discharge gas, and ultraviolet light generated by the gas discharge excites color phosphors and converts their wavelengths, thereby generating red color (hereinafter, called R), green color (hereinafter, called G), blue color (hereinafter, called B), so that a color image is displayed.

Red, green, and blue phosphor layers are made of phosphor particles of the respective colors. Naming examples of the respective color phosphors conventionally used,

red phosphor; (Y,Gd)BO₃:Eu³⁺ (hereinafter, called YGB phosphor), Y(P,V)O₄:Eu³⁺ (hereinafter, called YPV phosphor), and Y₂O₃:Eu³⁺ (hereinafter, called YOX phosphor)
green phosphor; Zn₂SiO₄:Mn²⁺ (hereinafter, called ZSM phosphor), YBO₃:Tb³⁺ (hereinafter, called YBT phosphor), and (Y, Gd) Al₃(BO₃)₄:Tb³⁺ (hereinafter, called YAB phosphor)
blue phosphor: BaMgAl₁₀O₁₇:Eu²⁺ (hereinafter, called BAM phosphor).

Along with the development of larger screens for televisions in which PDP is used in recent years, PDP is now increasingly applied to, for example, high-definition display such as full-spec high vision and stereoscopic display. An advantage of PDP as compared to liquid crystal panels is the capability of simplified high-speed drive. Such an advantage is intensifying the development of, for example, a stereoscopic image display apparatus in which PDP and liquid crystal shutter glasses are combined.

As to the time of afterglow in the color phosphors, the following documents can be referenced; Patent Document 1 (Unexamined Japanese Patent Publication No. 2003-45343), Patent Document 2 (Unexamined Japanese Patent Publication No. 2006-193712), and Patent Document 3 (Unexamined Japanese Patent Publication No. 2009-185275), respectively disclosing the phosphors and PDP structures. Patent Document 1 and Non-Patent Document 1 (Hirokazu Hamada et. al., R&D, NHK Science & Technology Research Laboratories, No. 71 (2002), pp. 26-35) disclose the time of afterglow in stereoscopic display using liquid crystal shutter glasses.

In the stereoscopic image display apparatus in which PDP and liquid crystal shutter glasses are jointly used, the high-speed drive of PDP is a prerequisite, therefore, it is necessary to fulfill the degree of image luminance, color tone and contrast of each R, G, or B light, and lifetime characteristics, and other requirements are to simplify and facilitate PDP manufacturing steps and shorten the time of afterglow.

To completely avoid the occurrence of crosstalk which is the double vision of image due to a response time of liquid crystal shutter glasses, it is necessary that 1/10 afterglow time, which is the time of afterglow of a phosphor (unless stated otherwise, the time of afterglow hereinafter means 1/10 afterglow time), be less than 2.3 msec, particularly at most 1.0 msec.

In the stereoscopic image display apparatuses disclosed in the Patent Document 1, Patent Document 2, and Non-Patent Document 1, however, the time of afterglow exceeds 2.3 msec, resulting in poor image luminance. Therefore, these stereoscopic image display apparatuses inevitably undergo crosstalk to no small extent, thereby deteriorating the image quality of stereoscopic images.

To reduce the time of afterglow in output lights from a plasma display device, it is the best to use particular phosphors alone, more specifically, phosphors which emit wavelength-converted light with ultra-short afterglow owing to parity-allowed emission transition. However, only a limited number of phosphors are high-efficiency phosphors which emit wavelength-converted light of any desirable color tone under the vacuum-ultraviolet excitation, let alone red phosphors with a high efficiency and color purity and such a short afterglow time as at most 2.3 msec, which can be hardly found.

### SUMMARY OF THE INVENTION

A plasma display device according to the present invention has a plasma display panel including phosphor layers which respectively emit lights through electric discharge to output blue, green, and red lights, wherein at least one of the green light and the red light is a wavelength-converted light which is a light emitted from a first phosphor and wavelength-converted by a second phosphor, the first phosphor is a phosphor selected from a plurality of phosphors having an emission peak in a wavelength region ranging from at least 200 nm to less than 600 nm, the second phosphor used to emit the green light is a green phosphor having an emission peak in a wavelength region ranging from at least 500 nm to less than 560 nm, and the second phosphor used to emit the red light is a red phosphor having an emission peak in a wavelength region ranging from at least 600 nm to less than 780 nm.

### BRIEF DESCRIPTION OF DRAWINGS

FIG. 1 shows a sectional perspective view of a PDP structure in a plasma display device according to exemplary embodiments of the present invention;

FIG. 2A shows a perspective view of an example of a stereoscopic image display apparatus in which the plasma display device according to the exemplary embodiments is used;

FIG. 2B shows a perspective view of an external appearance of image viewing glasses used to view images displayed on the stereoscopic image display apparatus;

FIG. 3 shows a block diagram of a drive circuit configuration in the plasma display device equipped with the PDP;

FIG. 4 shows a graph of emission characteristics of a Eu²⁺-activated nitride-based red phosphor;

FIG. 5 shows a sectional view of a PDP structure according to a first embodiment of the present invention;

FIG. 6 shows a graph of an example of afterglow characteristics of red, green, and blue lights in the PDP according to the first embodiment; and

FIG. 7 shows a sectional view of a PDP structure according to a second embodiment of the present invention.

### DETAILED DESCRIPTION OF THE PREFERRED EMBODIMENT

Hereinafter, exemplary embodiments of the present invention are described referring to the drawings.

### First Embodiment

FIG. 1 is a sectional perspective view of a PDP structure in a plasma display device according to exemplary embodiments of the present invention.

Referring to FIG. 1, the plasma display device has discharge light generator 10B, and discharge light generator 10B includes front panel 20 and back panel 30

Front panel 20 has front glass substrate 21. A plurality of display electrode pairs 24 including scan electrodes 22 and sustain electrodes 23 disposed in parallel with each other are formed on front glass substrate 21.

Dielectric layer 25 is formed so as to cover scan electrodes 22 and sustain electrodes 23. Dielectric layer 25 is coated with protective layer 26 formed thereon.

Back panel 30 has back glass substrate 31. Address electrodes 32disposed in parallel with each other are formed on back glass substrate 31. Ground dielectric layer 33 is formed so as to cover address electrodes 32, and barrier ribs 34 are formed on ground dielectric layer 33. Front panel 20 and back panel 30 are disposed facing each other so that display electrode pairs 24 and address electrodes 32 intersect with each other with a discharge space interposed therebetween. A sealing member, such as glass frit, seals outer peripheral portions of front panel 20 and back panel 30.

The discharge space is a very small space encompassed by side faces of barrier ribs 34 and ground dielectric layer 33. The discharge space is provided with phosphor layers 35 of red, green, and blue pixels for each of address electrodes 32 so that phosphor layers 35 are in contact with wall surfaces of the discharge space.

A discharge gas is enclosed in the discharge space. Examples of the discharge gas include a neon (Ne)-xenon (Xe) mixed gas. The mixed gas is enclosed in the discharge space under a pressure in the range of 55 kPa to 80 kPa. Examples of the discharge gas, other than the neon (Ne)-xenon (Xe) mixed gas, also include argon (Ar) gas and nitrogen (N₂) gas.

The discharge space is divided into a plurality of spaces by barrier ribs 34, and discharge cells 36 are formed at sections where display electrode pairs 24 and address electrodes 32 intersect with each other. When a discharge voltage is applied to between the electrodes, an electric discharge is induced in discharge cells 36. A discharge light generated by the electric discharge (for example, ultraviolet light, not shown) excites phosphors of phosphor layers 35 constituting the pixels, causing the emission of wavelength-converted lights. The structure of discharge light generator 10B is not necessarily limited to the described structure. Barrier ribs 34 may have a cross-shaped structure.

A description is given below of the application of the plasma display device as mentioned above to stereoscopic image display apparatus 100.

FIG. 2A is a perspective view showing an example of stereoscopic image display apparatus 100 in which the plasma display device is used. FIG. 2B is a perspective view showing an external appearance of image viewing glasses 120 used to view images displayed on stereoscopic image display apparatus 100.

When a user wears image viewing glasses 120 to watch images displayed on a display screen of stereoscopic image display apparatus 100, the images can be presented as stereoscopic images. Stereoscopic image display apparatus 100 displays on the display screen an image for right eye and an image for left eye in turn.

Image viewing glasses 120 regulate incident lights to right and left eyes thereof using a liquid crystal shutter as an optical filter in synchronization with the images outputted to the display screen of stereoscopic image display apparatus 100.

Only the images already subjected to a predetermined stereoscopic process (3D image process) are displayed on the display screen of stereoscopic image display apparatus 100. The images for right and left eyes are different due to a parallax difference therebetween. The user can visually recognize that stereoscopic image display apparatus 100 is displaying stereoscopic images by detecting the parallax difference between the images that he/she is watching with his/her right and left eyes.

More specifically, a signal synchronous to an image outputted to the display screen of the plasma display device is transmitted from synchronous signal transmitter 110 of stereoscopic image display apparatus 100 and received by synchronous signal receiver 130 of image viewing glasses 120, and image viewing glasses 120 perform a predetermined optical process to the incident lights entering the left and right eyes based on the synchronous signal. As a result of the process, the image displayed on stereoscopic image display apparatus 100 is visually recognized as a three dimensional image by the user who is wearing image viewing glasses 120.

In the case where image viewing glasses 120 are provided with a liquid crystal shutter, an infrared emitter can be used as synchronous signal transmitter 110 of stereoscopic image display apparatus 100, and an infrared sensor can be used as synchronous signal receiver 130 of image viewing glasses 120.

Thus, stereoscopic image display apparatus 100 according to the present exemplary embodiment includes the plasma display device and image viewing glasses 120 provided with the liquid crystal shutter which opens and closes at the frequency of 120 Hz. Therefore, it is necessary to avoid crosstalk which results in the double vision of any images of stereoscopic image display apparatus 100 when the liquid crystal shutter opens and closes at the frequency of 120 Hz. To avoid crosstalk, the time of afterglow of the wavelength-converted lights emitted from the respective color phosphors of PDP 10A should be at most 3.5 msec. Then, the three dimensional image can be displayed in an eye-friendly manner as a more real and powerful image.

FIG. 3 is a block diagram of a drive circuit in the plasma display device in which PDP 10A is used. When the plasma display device is used in stereoscopic image display apparatus 100, an electric discharge is generated in a circuit configured similarly to drive circuit 40 shown in FIG. 3. The plasma display device includes PDP 10A and drive circuit 40 connected to PDP 10A. Drive circuit 40 includes display driver circuit 41, display scan driver circuit 42, and address driver circuit 43. These circuits are connected to sustain electrodes 23, scan electrodes 22, and address electrodes 32 of PDP 10A. Controller 44 regulates drive voltages to be applied to these different electrodes.

The electric discharge in PDP 10A is described below.

First, a predetermined voltage is applied to scan electrodes 22 and address electrodes 32 corresponding to discharge cell 36 to be lighted up (an example is shown in FIG. 5) to effect an address discharge, so that wall charges are formed in discharge cell 36 corresponding to display data. When a sustain discharge voltage is thereafter applied to between sustain electrodes 23 and scan electrodes 22, a sustain discharge thereby induced in discharge cell 36 where the wall charges are formed generates ultraviolet radiation. The phosphors in phosphor layers 35 excited by the ultraviolet radiation emit the wavelength-converted lights, lighting on discharge cell 36. An image is displayed depending on which of discharge cells 36 of the respective colors is or is not lighted up.

A method for manufacturing discharge light generator 10B of PDP 10A according to the present exemplary embodiment is described below referring to FIG. 1.

First, a method for manufacturing front panel 20 is described.

A plurality of display electrode pairs 24 including scan electrodes 22 and sustain electrodes 23 disposed in parallel with each other are formed on front glass substrate 21.

To form scan electrodes 22 and sustain electrodes 23 constituting display electrode pairs 24, a silver paste for electrode is screen-printed on front glass substrate 21 and then fired, or a transparent electrode material such as In—Sn—O is deposited in the form of a film by sputtering or evaporation. If necessary, bus electrodes (not shown) may be additionally provided in contact with scan electrodes 22 and sustain electrodes 23 to reduce wiring resistances.

A paste including a glass material is spread by die coating or screen printing so as to cover scan electrodes 22 and sustain electrodes 23 and then fired so that dielectric layer 25 is formed, and protective layer 26 is formed on dielectric layer 25.

Protective layer 26 is formed by depositing alkali-earth metal oxide (for example, MgO or (Sr,Ca)O) or the like, by sputtering or electronic beam evaporation.

Next, a method for manufacturing back panel 30 is described.

A plurality of address electrodes 32 are formed in the shape of stripes on back glass substrate 31. To form address electrodes 32, a silver paste for electrode is screen-printed on back glass substrate 31 and then fired, or a transparent electrode material such as In—Sn—O is deposited in the form of a film by sputtering or evaporation.

A paste including a glass material is spread by die coating or screen printing so as to cover address electrodes 32 and then fired so that ground dielectric layer 33 is formed, and barrier ribs 34 are formed on ground dielectric layer 33. To form barrier ribs 34, for example, a paste including a glass material may be repeatedly spread in the form of stripes by screen printing with address electrodes 32 interposed therebetween and then fired, or the paste may be spread on ground dielectric layer 33 so as to cover address electrodes 32, and then patterned and fired. Barrier ribs 34 thus formed divide the discharge space into subdivisions to form discharge cells 36. A void between barrier ribs 34 is set to 130 μm to 240 μm to meet the requirements of 42-inch to 50-inch HD televisions and full HD televisions.

A paste including phosphor material particles is spread between two each of adjacent barrier ribs 34 by screen printing, inkjet method or the like and then fired so that phosphor layers 35 are formed. As a result, back panel 30 is obtained.

Finally, a method for manufacturing the plasma display device is described.

Front panel 20 and back panel 30 are put together so as to face each other so that scan electrodes 22 of front panel 20 and address electrodes 32 of back panel 30 are orthogonal to each other.

Then, peripheral sections of front panel 20 and back panel 30 are coated with a sealing glass (not shown) so that the panels are sealed to each other. After the discharge space is evacuated to high vacuum, the neon (Ne)-xenon (Xe) mixed gas, for example, is enclosed in the evacuated discharge space under a pressure in the range of 55 kPa to 80 kPa. As a result, discharge light generator 10B is obtained.

Discharge light generator 10B thus produced is provided with wavelength converter 350 and optical filters 500, if necessary. Then, PDP 10A according to the present exemplary embodiment is obtained.

Phosphor layers 35 may be divided into, for example, red phosphor layer 35R, green phosphor layer 35G, and blue phosphor layer 35B to be used as wavelength converter 350.

Drive circuit 40 is connected to PDP 10A thus obtained, and a cabinet, for example, is further provided, so that the plasma display device is manufactured.

The output lights emitted from PDP 10A according to the present exemplary embodiment, and phosphors used in discharge light generator 10B (first phosphor 135) and phosphors used in wavelength converter 350 (second phosphor 235) are described referring to Table 1.

TABLE 1

| | | | | | Options of second | |
|---|---|---|---|---|---|---|
| | Options of first phosphor 135 | | | | phosphor 235 | |
| | | Type of | Subdivision | Emission peak | | Emission peak |
| Output | Color | color | of color | wavelength | Color | wavelength |
| light | phosphor | phosphor | phosphor | (nm) | phosphor | (nm) |
| Red | Phosphor | Phosphor | Ultraviolet | 200-380 | Red | 600-780 |
| light | R | R1 | phosphor | | phosphor | |
| | | | Violet | 380-420 | | |
| | | | phosphor | | | |
| | | | Blue | 420-500 | | |
| | | | phosphor | | | |
| | | | Green | 500-560 | | |
| | | | phosphor | | | |
| | | | Yellow | 560-600 | | |
| | | | phosphor | | | |
| | | Phosphor | Red | 600-780 | No | — |
| | | R0 | phosphor | | phosphor | |
| Green | Phosphor | Phosphor | Ultraviolet | 200-380 | Green | 500-560 |
| light | G | G1 | phosphor | | phosphor | |
| | | | Violet | 380-420 | | |
| | | | phosphor | | | |
| | | | Blue | 420-500 | | |
| | | | phosphor | | | |
| | | Phosphor | Green | 500-560 | No | — |
| | | G0 | phosphor | | phosphor | |
| Blue | Phosphor | Phosphor | Ultraviolet | 200-380 | Blue | 420-500 |
| light | B | B1 | phosphor | | phosphor | |
| | | | Violet | 380-420 | | |
| | | | phosphor | | | |
| | | Phosphor | Blue | 420-500 | No | — |
| | | B0 | phosphor | | phosphor | |

The technical idea of PDP 10A according to the present exemplary embodiment does not particularly limit luminescent colors of the output lights. To provide a plasma display device capable of full color display highly coveted in the market, however, first phosphor 135 and second phosphor 235 are preferably selected so that red light 501R, green light 501G, and blue light 501B representing three primary colors of light are emitted as the output lights.

Table 1 shows technical options of first phosphor 135 and second phosphor 235 to obtain red light 501R, green light 501G, and blue light 501B as the output light.

In Table 1, the options of first phosphor 135 in order to obtain red light 501R, green light 501G, and blue light 501B as the output lights are defined as phosphor R, phosphor G, and phosphor B.

Hereinafter, the technical options are specifically described. The present exemplary embodiment is characterized in that, of the technical options shown in Table 1, at least one of green light 501G and red light 501R is a wavelength-converted light which is a light emitted from first phosphor 135 and wavelength-converted by second phosphor 235.

First, the options of second phosphor 235 are described.

To obtain red light 501R, a light emitted from a red phosphor as second phosphor 235 is wavelength-converted and used, or a light emitted from a red phosphor as first phosphor 135 is directly used.

To obtain green light 501G, a light emitted from a green phosphor as second phosphor 235 is wavelength-converted and used, or a light emitted from a green phosphor as first phosphor 135 is directly used.

To obtain blue light 501R, a light emitted from a blue phosphor as second phosphor 235 is wavelength-converted and used, or a light emitted from a blue phosphor as first phosphor 135 is directly used.

Next, the technical options of first phosphor 135 are described.

First phosphor 135 in order to obtain red light 501R (phosphor R) can be selected from a phosphor which emits a light capable of exciting a red phosphor as second phosphor 235 (phosphor R1), and a phosphor which emits red light 501R (phosphor R0).

More specifically, first phosphor 135 that can function as phosphor R is a phosphor that can be excited by the discharge light and having an emission peak having a wavelength longer than a peak wavelength of the discharge light.

Further, the first phosphor 135 is one of a phosphor which emits a light having an emission peak having a wavelength shorter than red light 501R emitted from a red phosphor (phosphor R1), and a red phosphor that can be excited by the discharge light (phosphor R0). Phosphor R1 is more specifically at least a phosphor selected from an ultraviolet phosphor, a violet phosphor, a blue phosphor, a green phosphor, and a yellow phosphor.

First phosphor 135 in order to obtain green light 501G (phosphor G) can be selected from a phosphor which emits a light capable of exciting a green phosphor as second phosphor 235 (phosphor G1), and a phosphor which emits green light 501G (phosphor G0).

More specifically, first phosphor 135 that can function as phosphor G is one of a phosphor that can be excited by the discharge light and having an emission peak having a wavelength longer than the peak wavelength of the discharge light and a phosphor which emits a light having an emission peak having a wavelength shorter than green light 501G emitted by a green phosphor (phosphor G1), and a green phosphor that can be excited by the discharge light (phosphor G0).

Phosphor G1 is more specifically at least a phosphor selected from an ultraviolet phosphor, a violet phosphor, and a blue phosphor.

First phosphor 135 in order to obtain blue light 501B (phosphor B) can be selected from a phosphor which emits a light capable of exciting a blue phosphor as second phosphor 235 (phosphor B1), and a phosphor which emits blue light 501B (phosphor B0). More specifically, first phosphor 135 that can function as phosphor B is a phosphor that can be excited by the discharge light and having an emission peak having a wavelength longer than the peak wavelength of the discharge light.

Further, first phosphor 135 is one of a phosphor which emits a light having an emission peak having a wavelength shorter than blue light 501B emitted from a blue phosphor (phosphor B1), and a blue phosphor that can be excited by the discharge light (phosphor B0). Phosphor B1 is more specifically at least a phosphor selected from an ultraviolet phosphor and a violet phosphor.

The ultraviolet phosphor, violet phosphor, blue phosphor, green phosphor, yellow phosphor, and red phosphor are respectively defined as a phosphor which emits a light having an emission peak in a far ultraviolet-near ultraviolet wavelength region ranging from at least 200 nm to less than 380 nm, a phosphor which emits a light having an emission peak in a violet wavelength region ranging from at least 380 nm to less than 420 nm, a phosphor which emits a light having an emission peak in a blue wavelength region ranging from at least 420 nm to less than 500 nm, a phosphor which emits a light having an emission peak in a green wavelength region ranging from at least 500 nm to less than 560 nm, a phosphor which emits a light having an emission peak in a yellow-red-orange wavelength region ranging from at least 560 nm to less than 600 nm, and a phosphor which emits a light having an emission peak in a red wavelength region ranging from at least 600 nm to less than 780 nm.

According to the present exemplary embodiment, a vacuum ultraviolet light released from the discharge light, for example, is wavelength-converted by first phosphor 135 into a light which efficiently excites second phosphor 235 (at least one of green phosphor and red phosphor) if necessary, and a light emitted from first phosphor 135 is used to excite second phosphor 235. This broadens the range of options of second phosphor 235 used to obtain high-output red, green, and blue lights with short afterglow.

As a result, the high-output lights with ultra-short afterglow, particularly red light 501R can be easily obtained by using commercially available phosphors alone. This provides a plasma display device wherein only the phosphors with short afterglow achieving the 1/10 afterglow time of less than 2.3 msec, preferably less than 1.0 msec, are used. As a result, stereoscopic image display device 100 thus obtained can eliminate the risk of crosstalk.

The phosphors with short afterglow used in the present exemplary embodiment are described in further detail.

The phosphors with short afterglow used in the plasma display device according to the present exemplary embodiment can be selected from a broad range of phosphors conventionally classified into MS, S, and VS indicating symbols of 10% afterglow time.

Specific examples are; phosphor indicating allowed transition, phosphor indicating emission transition that requires donor or acceptor, and phosphor in which complex ion is an emission center. The following phosphors can be used as the ultraviolet phosphor, violet phosphor, blue phosphor, green phosphor, yellow phosphor, and red phosphor shown in Table 1 as the options of first phosphor 135 or second phosphor 235.

### 1) Rare-Earth Phosphor Indicating Parity-Allowed Transition or Spin-Allowed Transition

Examples of Ce³⁺-activated phosphor (parity-allowed transition) that can be used are listed below.

ultraviolet emission phosphor; YAlO₃:Ce³⁺, CeMgAl₁₁O₁₉, YPO₄:Ce³⁺, LaPO₄:Ce³⁺, LaMgB₅O₁₀:Ce³⁺, LaB₃O₆:Ce³⁺
violet emission phosphor; Ca₂MgSi₂O₇, Y₂SiO₄:Ce³⁺
green emission phosphor; Y₃Al₅O₁₂:Ce³⁺

Examples of Eu²⁺-activated phosphor (parity-allowed transition) that can be used are listed below.

ultraviolet emission phosphor; SrB₄O₇:Eu²⁺
violet emission phosphor; (Sr,Ba)Al₂Si₂O₈:Eu²⁺
blue emission phosphor; BaMgAl₁₀O₁₇:Eu²⁺, CaMgSi₂O₆:Eu²⁺, Sr₁₀(PO₄)₆Cl₂:Eu²⁺, Sr₄Si₃O₈Cl₄:Eu²⁺, Ba₃MgSi₂O₈:Eu²⁺
green emission phosphor; Ba₃Si₆O₁₂N₂:Eu²⁺, Si₃N₄:Eu²⁺
yellow emission phosphor; Ca-α-SiAlON:Eu²⁺
red emission phosphor; Sr₂Si₅N₈:Eu²⁺, SrAlSi₄N₇:Eu²⁺, CaAlSiN₃:Eu²⁺

As an example of Yb²⁺-activated phosphor (parity-allowed transition) that can be used, green emission phosphor; Ca-α-SiAlON:Yb²⁺.

Other than the given examples, phosphors such as Pr³⁺-activated phosphor (spin-allowed transition (parity-forbidden)) can be used.

2) Phosphor in which Parity-Allowed Transition ns² Ion is an Emission Center

Examples of Sn²⁺-activated phosphor that can be used are listed below.

violet emission phosphor; SrMgP₂O₇:Sn²⁺
red emission phosphor; (Sr,Mg)₃(PO₄)₂:Sn²⁺

As an example of Sb³⁺-activated phosphor that can be used, blue emission phosphor; 3Ca₃(PO₄)₂. Ca(F,Cl)₂:Sb³⁺.

Examples of Tl⁺-activated phosphor that can be used are listed below.

ultraviolet emission phosphor; Ca₃(PO₄)₂:Tl⁺
violet emission phosphor; Zn₂SiO₄:Tl⁺
green emission phosphor; (Ca,Mg)SiO₃:Tl⁺

Examples of Pb²⁺-activated phosphor that can be used are listed below.

ultraviolet emission phosphor; BaSi₂O₅:Pb²⁺
blue emission phosphor; CaWO₄:Pb²⁺

Other than the given examples, phosphors such as Cu⁺-activated phosphor and Bi³⁺-activated phosphor can be used as well.

3) Phosphor Indicating Emission Transition that Requires Donor or Acceptor
blue emission phosphor; ZnS:Ag, ZnS:Ag, Cl
green emission phosphor; ZnS:Cu, Al.
4) Phosphor in which Complex Ion is an Emission Center

Examples that can be used are listed below.

violet emission phosphor; CaWO₄
blue emission phosphor; Y(P,V)O₄

A red emission phosphor preferably used as second phosphor 235 is a nitrogen-based Eu²⁺-activated phosphor.

The nitrogen-based Eu²⁺-activated phosphor can efficiently absorb any of near ultraviolet light, violet light, and blue light 501B, and then wavelength-convert these lights into red light 501R having a favorable color purity (having an emission peak near 620 to 660 nm) with a high photon conversion efficiency near 100% of a theoretical limit. Therefore, the nitrogen-based Eu²⁺-activated phosphor is a favorable example in view of such a high efficiency, high color purity, and short afterglow.

For reference, FIG. 4 illustrates an excitation wavelength dependency of excitation spectrum, emission spectrum, and internal quantum efficiency (photon conversion efficiency) in a typical nitrogen-based Eu²⁺-activated red phosphor (hereinafter, recited as Eu²⁺-activated red nitrogen phosphor).

In FIG. 4, a lateral axis of a graph shown therein represents a wavelength (nm), and a longitudinal axis represents the intensity of light emission (a.u.) and an internal quantum efficiency (%) of the Eu²⁺-activated red nitrogen phosphor. The internal quantum efficiency is a percentage of number of photons emitted from the phosphor to number of photons absorbed by the phosphor. In FIG. 4, the obtained values are expressed in absolute values. More specifically describing FIG. 4, the distribution of black circles represents the internal quantum efficiency of the Eu²⁺-activated red nitrogen phosphor, the thin line represents the excitation spectrum of the Eu²⁺-activated red nitrogen phosphor, and the solid line represents the emission spectrum of the Eu²⁺-activated red nitrogen phosphor.

As shown in FIG. 4, the nitrogen-based Eu²⁺-activated red phosphor not only efficiently absorbs the near ultraviolet light, violet light, and blue light 501B but also absorbs the yellow light and green light 501G, and wavelength-converts a broad range of lights ranging from near ultraviolet to yellow wavelength regions with a high internal quantum efficiency exceeding 85% into red light 501R having an emission peak around 650 nm.

FIG. 5 is a sectional view showing a structure of PDP 10A according to a first embodiment. More specifically, FIG. 5 illustrates a structure where phosphor layer 35 including first phosphor 135 is provided in discharge cell 36 encompassed by barrier rib 34 and ground dielectric layer 33 of back panel 30, and the light emitted from first phosphor 135 passes through the discharge space and thereafter excites second phosphor 235.

According to the present exemplary embodiment, the discharge light emitted from discharge cell 36 is wavelength-converted by first phosphor 135 into at least any of the ultraviolet, violet, blue, green, and yellow lights, and the wavelength-converted light emitted from first phosphor 135 is wavelength-converted by second phosphor 235 into at least any of the blue, green, and yellow, and red lights. The output lights are released from a surface of PDP 10A on the side of front panel 20.

In FIG. 5, phosphor layers 35 including second phosphor 235 serve as wavelength converter 350. At least one of the green phosphor and red phosphor is included as second phosphor 235. In FIG. 5 showing the first embodiment, whole phosphor layers 35 including first phosphor 135 are blue phosphor layer 35B. Wavelength converter 350 including second phosphor 235 has red phosphor layer 35R and green phosphor layer 35G which respectively emit the red and green lights, but not blue phosphor layer 35B.

Unless phosphor R0 and phosphor G0 are used as first phosphor 135 at the same time, first phosphor 135 can be arbitrarily selected from the options of first phosphor 135 shown in Table 1 in first. Phosphor layers 35 including first phosphor 135 may be arranged to emit any one of the ultraviolet light, violet light, blue light 510B, green light 501G, and yellow light. In phosphor layers 35 including first phosphor 135, the same phosphor can be selected as any of phosphor R, phosphor G, and phosphor B, or different phosphors may be used for these phosphors. In the case where all of phosphor R, phosphor G, and phosphor B in phosphor layers 35 including first phosphor 135 are the same phosphor, the phosphor used therein can be arranged to emit any of the ultraviolet light, violet light, and blue light 501B.

Phosphor layers 35 including second phosphor 235 are preferably arranged to emit any of green light 501G and red light 501R. In second phosphor 235, phosphor R0 and phosphor G0 are used at the same time as first phosphor 135. Unless the red and green phosphors are used as second phosphor 235, any phosphor can be arbitrarily selected from the options of second phosphor 235 shown in Table 1. A possible arrangement of second phosphor 235 is not to use the green phosphor, or to selectively use the blue phosphor.

According to the first embodiment, PDP 10A is manufactured by a conventional manufacturing process, and at least wavelength converter 350is additionally provided in PDP 10A.

Therefore, a light emission device which at least emits large output lights characterized as having such a short afterglow that the 1/10 afterglow time is less than 2.3 msec, particularly the R/G/B light components, can be relatively easily manufactured. Many options of the second phosphor 235 that can be used as wavelength converter 350 are characterized in absorbing outside light and wavelength-converting the absorbed light into a visible light having a longer wavelength, thereby easily inducing the deterioration of contrast in the plasma display device. To prevent the contrast deterioration, a structure which suppresses the excitation of second phosphor 235 induced by outside light is provided on the side of a light emission surface of phosphor layer 35 including second phosphor 235. A preferable example is to provide optical filters 500 (500R, 500G, 500B) which absorb a light having a wavelength shorter than that of the light emitted from second phosphor 235 on the side of the light emission surface of at least one phosphor layer 35 including second phosphor 235.

In the plasma display device according to the present exemplary embodiment, at least one of blue light 501B, green light 501G, and red light 501R preferably passes through optical filters 500 which absorb a light having a wavelength shorter than the peak wavelengths of blue light 501B, green light 501G, and red light 501R to be outputted.

This makes it difficult for second phosphor 235 to be excited by outside light, and also makes the light emission from second phosphor 235 unlikely when outside light is irradiated thereon. As a result, the contrast deterioration can be prevented from happening in the plasma display device.

The location of phosphor layers 35 including second phosphor 235 (wavelength converter 350) is not necessarily limited to a light emission surface of front panel 20 shown in FIG. 5.

In FIG. 6, showing an example of afterglow characteristics of the output lights in the PDP according to the first embodiment. More specifically describing FIG. 6, a lateral axis represents time (msec) after the discharge is OFF in the PDP, and a longitudinal axis represents emission intensities of RGB pixels in the PDP (a.u.).

FIG. 6 illustrates afterglow characteristics of the output lights in the case where an Eu²⁺-activated aluminate phosphor (blue emission BaMgAl₁₀O₁₇:Eu²⁺) is used as first phosphor 135, an Eu²⁺-activated aluminosilicate phosphor (red emission CaAlSiN₃:Eu²⁺) and a Ce³⁺-activated yttrium aluminum garnet phosphor (green emission Y₃Al₅O₁₂:Ce²⁺) are used as second phosphor 235, and red light 501R, green light 501G, and blue light 501B are respectively red light 501R from CaAlSiN₃:Eu²⁺, green light 501G from Y₃Al₅O₁₂:Ce²⁺, and blue light 501B from BaMgAl₁₀O₁₇:Eu²⁺.

For reference, FIG. 6 further illustrates an example of afterglow characteristics of the output lights in a conventional PDP structure in which a Y(P,V)O₄:Eu³⁺ is used as the red phosphor, a mixed phosphor of Y₃Al₅O₁₂:Ce²⁺ and Zn₂SiO₄:Mn²⁺ is used as the green phosphor, and BaMgAl₁₀O₁₇:Eu²⁺ is used as the blue phosphor.

a) and b) of FIG. 6 respectively illustrate afterglow characteristics of red light 501R and green light 501G in the PDP structure according to the present exemplary embodiment. c) and d) of FIG. 6 respectively illustrate afterglow characteristics of red light 501R and green light 501G in the conventional PDP structure. e) of FIG. 6 illustrates afterglow characteristics of blue light 501B in the conventional PDP structure and the PDP structure according to the present application. More specifically, a longitudinal axis represents the intensity of light emission, and a lateral axis represents a passage of time after the discharge light is turned off. A timeframe for the intensity of light emission to decrease from 100 to 10 is conventionally defined as the 1/10 afterglow time.

In the conventional PDP structure, the time of afterglow is less than 1.0 msec in blue light 501B, however, the time of afterglow exceeds 1.0 msec and stays in the range of 3.0 to 3.5 msec in red light 501R and green light 501G both as shown in c) and d).

In the PDP structure according to the present exemplary embodiment, the afterglow time is less than 1.0 msec in red light 501R and green light 501G both as shown in a) and b). Thus, the present exemplary embodiment largely reduces the time of afterglow in particularly red light 501R and green light 501G to less than 1.0 msec.

Either of inorganic or organic phosphors can be used. At least one of first phosphor 135 and second phosphor 235, particularly second phosphor 235, may be a fluorescent pigment including a fluorescent coloring agent. This is an advantageous material in view of cost reduction.

When any organic phosphor is used, the 1/10 afterglow time is desirably less than 2.3 msec, and more desirably less than 1.0 msec. When the organic phosphor characterized as having such a short afterglow is used, stereoscopic image display apparatus 100 in which crosstalk is significantly reduced can be obtained.

### Second Embodiment

Next, emission characteristics of a PDP according to a second embodiment of the present invention are described below. Any technical similarity to the first embodiment is omitted in the description given below.

FIG. 7 is a sectional view showing a structure of PDP 10A according to the second embodiment, wherein phosphor layers 35 including first phosphor 135 are provided in discharge cell 36 encompassed by barrier rib 34 and ground dielectric layer 33 of back panel 30. The light emitted from first phosphor 135 excites second phosphor 235 without passing through the discharge space.

In the example shown in FIG. 7, phosphor layers 35 including first phosphor 135 and phosphor layers 35 including second phosphor 235 are provided in discharge cell 36 encompassed by barrier rib 34 and ground dielectric layer 33 of back panel 30, and wavelength converter 350 shown in FIG. 5 is provided in discharge cell 36.

In the present exemplary embodiment, the generated discharge light is similarly wavelength-converted by first phosphor 135 into at least any of the ultraviolet, violet, blue, green, and yellow lights. Then, the wavelength-converted light generated by first phosphor 135 is wavelength-converted by second phosphor 235 into at least any of blue, green, yellow, and red lights. In the present exemplary embodiment, the output lights are released from a surface of PDP 10A on the side of back panel 30.

In the example shown in FIG. 7, 1) whole phosphor layers 35 including first phosphor 135 are blue phosphor layer 35B, 2) phosphor layers 35 including second phosphor 235 have green phosphor layer 35G and red phosphor layer 35R, and 3) the light released from PDP 10A is blue light 501B emitted from blue phosphor layer 35B, green light 501G emitted from green phosphor layer 35G, and red light 501R emitted from red phosphor layer 35R. However, the present exemplary embodiment is not necessarily limited thereto.

Similarly to the PDP structure described earlier, first phosphor 135 and second phosphor 235 can be arbitrarily selected from the options of first phosphor 135 shown in Table 1.

Phosphor layers 35 including first phosphor 135 and phosphor layers 35 including second phosphor 235 are arranged in the same manner as in the description of the PDP structure given earlier, therefore, will not be described again.

The location of phosphor layers 35 including second phosphor 235 is not necessarily limited to inside of discharge cell 36 encompassed by barrier rib 34 and ground dielectric layer 33 of back panel 30 as shown in FIG. 7.l

Phosphor layers 35 including second phosphor 235 may be located elsewhere as far as the light emitted from first phosphor 135 excites second phosphor 235 without passing through the discharge space.

Similarly to the PDP structure described earlier, the PDP which emits large output lights characterized as having such a short afterglow that the 1/10 afterglow time is less than 2.3 msec, particularly the R/G/B lights can be relatively easily manufactured by using a conventional PDP manufacturing process.

Based on a reason similar to the reason described in the first embodiment, in the present exemplary embodiment, it is preferable to provide a structure which suppresses excitation of second phosphor 235 induced by outside light, such as optical filters 500 (500R, 500G, 500B) which absorb a light having a wavelength shorter than that of the light emitted from second phosphor 235 on the light emission surface of at least one phosphor layer 35 including second phosphor 235.

Phosphor support member 300 shown in FIG. 7 is provided to help phosphor layers 35 be easily formed in an even thickness in discharge cell 36 and made of, for example, a transparent glass material.

Phosphor support member 300 is not an indispensable structural element of the present exemplary embodiment. Phosphor support member 300 can be obtained by spreading a paste containing a glass material by screen printing.

As described so far, the present exemplary embodiment provides the plasma display device including the plasma display panel having phosphor layers 35 which emit light through electric discharge to emit the output lights, blue light 501B, green light 501G, and red light 501R, wherein at least one of green light 501G and red light 501R is a wavelength-converted light which is a light emitted from first phosphor 135 and wavelength-converted by second phosphor 235, first phosphor 135 is a phosphor selected from a plurality of phosphors having an emission peak in a wavelength region ranging from at least 200 nm to less than 600 nm, second phosphor 235 used to emit the green light 510G is a green phosphor having an emission peak in a wavelength region ranging from at least 500 nm to less than 560 nm, and second phosphor 235 used to emit red light 501R is a red phosphor having an emission peak in a wavelength region ranging from at least 600 nm to less than 780 nm. The plasma display device thus provided can wavelength-convert the discharge light with a high photon conversion efficiency using any existing phosphors commercially available, thereby releasing high-output green light 501G and red light 501R having short afterglow characteristics.

First phosphor 135 and second phosphor 235 are phosphors activated by emission center ions indicating light emission based on parity-allowed transition. Therefore, the plasma display device thus provided is technically advantageous in that ultra-short afterglow characteristics are achieved with the 1/10 afterglow time below 1.0 msec.

What is claimed is:

1. A plasma display device, comprising a plasma display panel including phosphor layers which respectively emit lights through electric discharge to output blue, green, and red lights, wherein
at least one of the green light and the red light is a wavelength-converted light which is a light emitted from a first phosphor and wavelength-converted by a second phosphor,
the first phosphor is a phosphor selected from a plurality of phosphors having an emission peak in a wavelength region ranging from at least 200 nm to less than 600 nm,
the second phosphor used to emit the green light is a green phosphor having an emission peak in a wavelength region ranging from at least 500 nm to less than 560 nm, and
the second phosphor used to emit the red light is a red phosphor having an emission peak in a wavelength region ranging from at least 600 nm to less than 780 nm.

2. The plasma display device according to claim 1, wherein
the first phosphor is a phosphor selected from a ultraviolet phosphor having an emission peak in a wavelength region ranging from at least 200 nm to less than 380 nm, a violet phosphor having an emission peak in a wavelength region ranging from at least 380 nm to less than 420 nm, a blue phosphor having an emission peak in a wavelength region ranging from at least 420 nm to less than 500 nm, a green phosphor having an emission peak in a wavelength region ranging from at least 500 nm to less than 560 nm, and a yellow phosphor having an emission peak in a wavelength region ranging from at least 560 nm to less than 600 nm.

3. The plasma display device according to claim 1, wherein
the first phosphor and the second phosphor are phosphors activated by an emission center ion indicating light emission based on parity-allowed transition.

4. The plasma display device according to claim 3, wherein
the first phosphor and the second phosphor are phosphors selected from a Ce³⁺-activated phosphor, an Eu²⁺-activated phosphor, a Yb²⁺-activated phosphor, a Sn²⁺-activated phosphor, a Sb³⁺-activated phosphor, a Tl⁺-activated phosphor, and a Pb²⁺-activated phosphor.

5. The plasma display device according to claim 1, wherein
the blue, green, and red output lights have 1/10 afterglow time less than 1.0 msec.
